(19) United States
(12) Patent Application Publication
(10) Pub. No.: US 2018/0045032 A1
(43) Pub. Date: Feb. 15, 2018

(54) DOWNHOLE MONITORING DEVICE ARRANGED IN-LINE WITH A SUCKER ROD STRING

(71) Applicant: Well Innovation AS, Royneberg (NO)

(72) Inventors: Rutger SUERMONDT, Algard (NO); Stian SLOTTERØY, Sandnes (NO); Przemyslaw Tomasz PALUCH, Sandnes (NO); John MACKAY, Sandnes (NO); Kim RØED, Stavanger (NO); Trond KJERLAND, Klepp Stasjon (NO); Trond Arild TVEIT, Hafrsfjord (NO); Krister Berven HANSSEN, Algard (NO)

(21) Appl. No.: 15/235,547

(22) Filed: Aug. 12, 2016

(51) Int. Cl. E21B 47/00; G01V 11/00; E21B 47/06; E21B 17/00; E21B 43/12

(52) U.S. Cl. CPC E21B 47/0008; E21B 17/00; E21B 43/126; E21B 47/06; E21B 47/065; E21B 47/00; G01V 11/002; E21B 2043/125

(57) ABSTRACT

The present invention concerns a downhole logging tool adapted to be arranged in-line in a sucker rod string. The tool is adapted for monitoring and performing at least one of: logging tension/compression, torque, temperature, pressure, and position (acceleration), for the purpose of optimizing (oil)well production and identifying downhole mechanical problems. The tool can be utilized in vertical, deviated and/or horizontal wells. Multiple monitoring tools can be installed in the sucker rod system in order to detect wear issues.

### TECHNICAL FIELD

The present invention relates to at least one monitoring device that is adapted to be arranged in-line with a sucker rod string.

### BACKGROUND ART

Today there is no system available that can directly measure the downhole behaviour of sucker rod(s) and pump connected to a surface pump jack system in either vertical, deviated and/or horizontal well(s). This, up until 15 years ago had not been an issue, because most wells were drilled vertically and it was assumed that the surface movement was directly representative of the downhole movement. This, for the most part, may have been a valid assumption for a vertical well or at least accepted by well operators, but as more and more wells are being drilled directionally, the assumptions used for the vertical well cases are being questioned by the well operator as no longer valid. Today the well operator is modelling the pump jack motion at surface based on the out-of-date vertical models and/or some limited research data that was collected by the Sandia National Laboratories in the 90's. This lack of data has resulted in lower production rates and an increase in workovers frequency due to the lack of downhole measurement associated with the increase in friction and drag resulting from the increase in well deviation. It is now more important than ever to understand the behaviour of the displacement pump. This lack of information on the rod system's behaviour downhole has resulted in increasing stresses in the rods, resulting in a higher frequency of workovers. This is a costly process during which the well's production must be shut-in for longer periods. Moreover, more and/or better downhole information will allow the well operator to adjust the surface equipment in order to maximize the output from the downhole pump, thereby increasing the production from the well. This applies to all wells regardless of depth.

There is a need to understand the loads, pump movement and pump discharge pressure at the pump in wells. By understanding both the dynamics at surface and downhole, it is thought that there will be enhanced production by longer pump run times, fewer workovers and reduced rod/tubing wear. And more importantly, utilizing the downhole information will lead to optimizing the surface system so production can be maximized. Today it is estimated that production rates are lower than expected due to not knowing what is happening downhole.

It is an object of the present invention to provide a tool that solves the problems indicated above.

### DISCLOSURE OF THE INVENTION

The invention explains a downhole monitoring device. The downhole monitoring device is adapted to be arranged in-line with a sucker rod string. The monitoring device comprises:
a housing adapted to be arranged in-line with the sucker rod string,
a plurality of sensors arranged within the housing and configured for sensing at least one of: sucker rod string conditions and sucker rod string surrounding conditions,
a data acquisition, storage and control electronic circuitry arranged within the housing and configured for data acquisition and storing,
a power supply arranged within the housing and configured for supplying the monitoring device with electrical power.

The plurality of sensors, the data acquisition, storage and control electronic circuitry and the power supply can be interconnected.

The plurality of sensors comprises at least one of: an accelerometer, a strain gauge, a pressure temperature (PT) sensor.

The housing comprises a top sub, a bottom sub and an intermediate main sub.

The top sub is connected to the bottom sub through the intermediate main sub.

The plurality of sensors can comprise at least one sensor being adapted for measuring at least one of: tension, compression and torque in the sucker rod string.

The electronic circuitry can be encapsulated and can comprise an accelerometer and electronics configured for data acquisition, processing and storage.

The plurality of sensors can further comprise sensors for measuring pressure and temperature in a well.

The sensors for measuring pressure and temperature (PT) in the well can be arranged in the bottom sub of the downhole monitoring device.

Said at least one sensor for measuring at least one of: tension, compression and torque in the sucker rod string, can be arranged in the bottom sub of the downhole monitoring device.

It is possible to have the plurality of sensors spread around, for example some sensors in the top sub and other sensors in e.g. the bottom sub and/or the intermediate sub.

According to one embodiment the power supply is arranged in the top sub. According to alternative embodiments the power supply can be arranged in the intermediate sub or the bottom sub. The power supply can comprise a battery pack.

The present invention concerns a tool that is a programmable, downhole (in an oil and/or gas well) in-line sucker rod monitoring device. The monitoring device is configured to monitor at least one of: logging tension/compression, torque, temperature, pressure, and position (acceleration), for the purpose of optimizing (oil)well production and identifying downhole mechanical problems. The device can be utilized in vertical, deviated and/or horizontal wells. Multiple monitoring devices can be installed in a sucker rod system to detect wear issues.

The downhole data will be correlated and analysed with surface data, which can be utilized in order to provide a vital understanding of how to optimize production and/or identify mechanical wear and/or problems on the sucker rod system or tubing/casing.

The monitoring device is arranged in the sucker rod string (top or bottom or various places throughout the string), and has the capability of recording a set of parameters through electronic sensors. The data acquired can be stored in a memory bank, with options to transmit to surface through a wired and/or wireless system(s). The monitoring device can be designed with different power supply configurations;

The monitoring device can be battery-operated. The batteries can be rechargeable and be charged from an external power supply in situ and/or remote from the monitoring device. Wireless charging of the rechargeable battery or batteries could also be possible.

The monitoring device can be fed by a remote power supply with or without a battery back-up. A surface-to-downhole electrical conductor or cable can be used.

Data communication between the monitoring device and top-side equipment can be wired or wireless according to transmission techniques known to the person skilled in the art.

To summarize the above, the purposes of the sucker rod string monitoring device according to the present invention is to optimize production in deviated wells, and increase the time between workovers.

The main features of this invention are given in the independent claims. Additional features of the present invention are given in the dependent claims.

Other advantageous features will be apparent from the accompanying claims.

### BRIEF DESCRIPTION OF THE DRAWINGS

Following is a brief description of the drawings in order to make the invention more readily understandable, the discussion that follows will refer to the accompanying drawings, in which:

FIG. 1 shows one embodiment of the monitoring device according to the present invention.

FIG. 2A-2C show some of the possible power supply configurations of the monitoring device according to the invention.

FIG. 3 illustrates schematically a system of the invention comprising a monitoring device, a sucker rod string and a sucker rod pump.

### MODE(S) FOR CARRYING OUT THE INVENTION

In the following it is firstly disclosed general embodiments in accordance to the present invention, thereafter particular exemplary embodiments will be described. Where possible reference will be made to the accompanying drawings and where possible using reference numerals in the drawings. It shall be noted however that the drawings are exemplary embodiments only and other features and embodiments may well be within the scope of the invention as described.

In the following description it will be adhered to the definitions below:

The sucker rod string monitoring device according to the present invention comprises at least one monitoring device that is adapted to be arranged in-line with a sucker rod string, where the monitoring device comprises one or more means for monitoring downhole conditions and/or position data. The monitoring device is a self-contained device, which can include a power supply for the device, either in the form of batteries, rechargeable or not, external power supply through wires with or without back-up batteries. Additionally, the monitoring device comprises an assembly of sensors and electronics. The monitoring device is included in a single housing and multiple monitoring devices can be distributed within the sucker rod string. It shall be appreciated that the monitoring device can be calibrated before operation through a channel interface, moreover the monitoring device is programmable and can be pre-programmed through the same interface. In addition, readout of data might be accomplished through this same interface.

### First Embodiment of the Present Invention

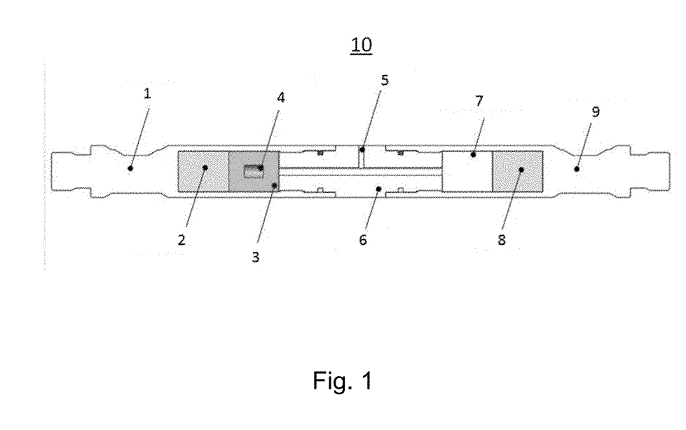

Reference is made to FIG. 1. FIG. 1 shows a block diagram of the monitoring device 10 which can be arranged anywhere in-line in the sucker rod string with the correct crossovers. The monitoring device includes a top sub portion 1, a bottom sub portion 9, and an intermediate main sub portion 6 in between. The monitoring device 10 comprises inside a power supply 2, electronics 3, accelerometer 4, communication port 5, strain gauges 7 and a Pressure Temperature (PT) sensor 8. The top 1 and bottom 9 subs of the monitoring device 10 are threaded, so that they can be screwed in-line with the mating sucker rod threads. The connections between the top sub 1, the middle sub 6 and the bottom sub 9 within the monitoring device 10 itself can be threaded, but it should be made allowances for torque, so a locking system for the middle 6 to the bottom 9 sub can be used, in order not to affect the calibration values. Another locking system for the top 1 to the middle 6 sub can also be used. It should be noted that other configurations of the monitoring device, according to the present invention, can be provided, and some examples will follow below.

The monitoring device can be specified for operation within a temperature range of approximately −5° C. and +200° C., in one specific embodiment it is specified for operation between +5° C. and +150° C.

The monitoring device can be specified for operation within a pressure range of approximately 1 psi (0.69 Bar) to 20,000 psi (517.11 Bar), in one specific embodiment it is specified for operation between 1 psi and 5,000 psi (344.74 Bar).

The monitoring device can be provided with a graphical user interface (GUI), the GUI will find its use before “Run in Hole” and/or during “real-time” operation and/or after “Pull out of Hole”. The GUI will facilitate configuration and administration of data acquisition (DAQ) functions and to analyse acquired data post operation and/or real-time. The GUI may also facilitate programming of the monitoring device and calibration of the monitoring device.

In one example, the GUI can be activated by plugging a connection into a communication port/interface port 5 provided on the body of the monitoring device. The electric connector can be any suitable connector.

In another example, the GUI can be included in the monitoring device itself. This can for instance be achieved by providing a visual inspection opening in the monitoring device, where the opening can be provided with tempered glass or some other type of bulkhead.

The interface between the monitoring device and the surface pump control system can also be facilitated by wireless communication. The wireless communication can be manually invoked after pull out of the hole, or it can be a continuous communication, while the monitoring device is in operation. To achieve a sufficient range, a number of relays/amplifiers can be provided along the sucker rod string and to the surface. In the event, the operation is subsea and in seawater, there exist communication equipment, which utilizes the conductivity of the seawater for signal transmission.

Telemetry systems, well-known to the person skilled in the art, can also be used for transmission of downhole data to the surface.

The power supply 2 can be a battery pack. This battery pack shall preferably at least have a capacity to run the monitoring device 10 for at least t plus months pump operation, although shorter and longer time intervals are also possible with the same device. In one embodiment, the battery pack can be replaced when the monitoring device 10 is disassembled.

The power supply can be facilitated by a wired power supply connection from top-side, where the wire is fed in the interior of the sucker rod string. Alternatively, with a return path/ground in the string material itself. It is also known in the art to use inductive power transmission. Current from the top-side can be AC or DC. In the event AC is used, a rectifier/AC/DC-converter can be a part of the monitoring device 10. Power can be supplied directly to the electronic components of the monitoring device 10 or it can feed a rechargeable battery, hence also providing automatic back-up in the event of a blackout. In FIG. 1, the power supply 2 is arranged adjacent to the top sub 1. The positioning of the power supply 2 is only indicated as an example, and the power supply 2 can be arranged elsewhere within the body of the monitoring device 10.

In FIG. 1, it is indicated that electronics 3 is arranged adjacent to the power supply 2. The electronics 3 receives power from the power supply 2. The electronics—or the electronic circuitry 3—regulates and/or monitors current and voltage. It regulates supply to peripheral elements. It can also provide the signalling interface between downhole and top-side equipment.

Typically, the electronic circuitry 3 will include a microprocessor, memories, clock circuitry, interface circuitry, such as modems, and in the event of wireless transmission: transceivers. The clock circuitry can include an internal clock for synchronisation purposes and a real time clock (RTC) for sufficient time stamping of collected data/parameters. The RTC will typically be synchronised with a top-side system clock. Successful control of the pump is dependent on reliable parameters from the monitoring device 10, hence top-side and downhole clocks must be in sync.

One or more accelerometers 4 are provided in the monitoring device. The electronic circuitry 3 may test and calibrate the accelerometer(s) 4 periodically or in response to instructions received from the top-side. The accelerometer(s) 4 will typically indicate(s) an inclination with reference to gravity. Most accelerometers indicate a “roughly” 9.8 ms⁻² when measuring in line with gravity towards the center of the earth. The Force vectors perpendicular to gravity are zero. For high precision, more than one accelerometer 4 can be used. The accelerometer 4 will give the top-side control system precise, or near precise, indication of the position of the relevant section of the sucker rod string and thereby also the position of the bottom of the downhole pump.

The accelerometer 4 can be a microelectronic, MEMS, chip/circuit, which can be embedded in the electronic circuitry 3.

The communication port 5 is indicated as a canal radially or with an angle out from the central longitudinal axis of the monitoring device 10. Electrical wiring between the electronic circuitry 3 and the communication port 5 is provided. The interface between the communication port 5 and external equipment can be of any suitable type, and the connector can be electrical, electro/optical or optical. The connector must be specified in accordance with the specification indicated above.

The strain gauges 7 will give an indication of the strain induced on the sucker rod string. The strain on the sucker rod string is an important parameter for the top-site control system, which regulates the pumping speed. As indicated above workover(s) can be reduced if strain/stresses is/are taken into consideration when pumping speed is set from the surface. The monitoring device 10 can be provided with one or more strain gauges 7.

The monitoring device can be provided with one or more PT sensors 8. Measuring the actual, as opposed to modelled, pump discharge pressure will enable a more accurate assessment of the pump intake pressure. This will further facilitate optimization of well performance and production. The one or more PT sensors 8 can provide temperature tracking to examine possible local heating of fluids leading to the potential for localized scaling (calcium carbonate).

The monitoring device 10 is used to compare downhole data to the surface data collected by the dynamometer gauge, which is not indicated in FIG. 1. Utilization of a dynamometer gauge can give valuable information to the surface pump control system, it will indicate the load and torques applied at the surface, and the monitoring device 10 will measure the loads and forces on the downhole pump and the sucker rod string. With mathematical models, an optimized solution can be achieved downhole. Other advantages of acquiring downhole sensor data can be:
Better understanding when compression loads appear, function of time, water cut changes, decrease in production volumes
Calibration of buckling models and side loads for deviated/tortuous well profiles enabling optimal placement of guides
Calibrate pump intake calculations for optimization efforts (increased production, lower power consumption, opportunities, set pump off controllers, operate pump off controllers)
Tie-in loading from use of ToughMet® couplings and/or rod guides
Overall reduce sucker rod pumping failures, improved reliability.

All of the sensor elements mentioned above communicates signal-wise and power-wise with the electronic circuitry 3.

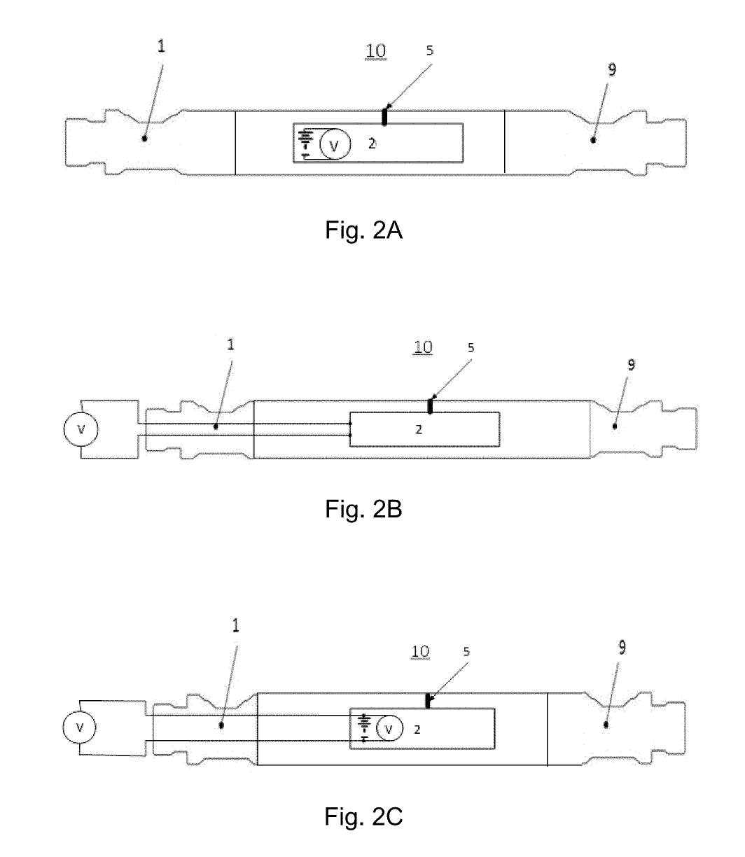

FIG. 2A-2C show some of the above-mentioned possible power supply 2 configurations of the monitoring device 10. In FIG. 2A, the power supply 2 is a battery. In FIG. 2B, the power supply 2 is an external power supply. FIG. 2C, shows a back-up power supply system comprising a rechargeable battery with an external power supply.

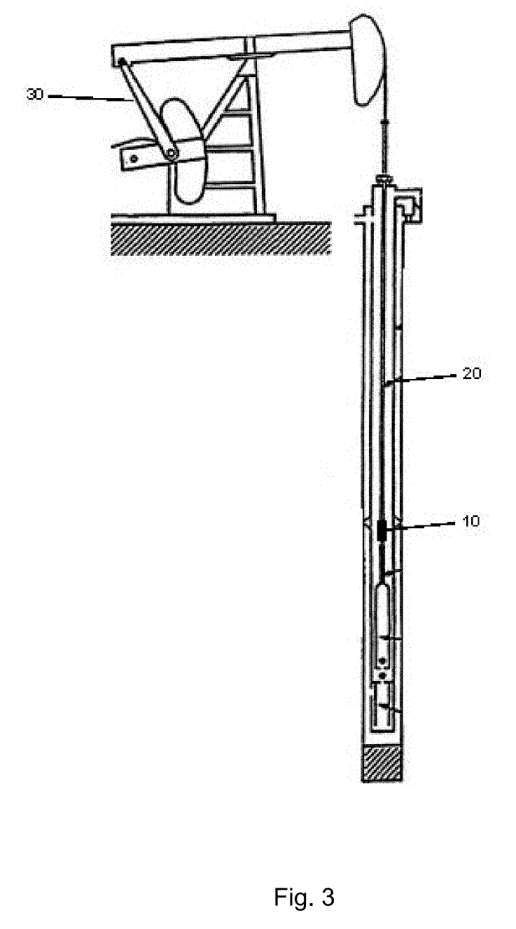

FIG. 3 illustrates schematically a system according to the invention, where the system comprises a monitoring device 10, a sucker rod string 20 and a sucker rod pump 30.

Additional modifications, alterations and adaptations of the present invention will suggest themselves to those skilled in the art without departing from the scope of the invention as expressed and stated in the following patent claims.

Component List

| | |
|---|---|
| 1 | Top Sub |
| 2 | Power supply |
| 3 | Electronics |
| 4 | Accelerometer |
| 5 | Communication port |
| 6 | Main sub/intermediate sub/intermediate main sub |
| 7 | Strain gauges |
| 8 | Pressure Temperature sensor/PT sensor |
| 9 | Bottom sub |
| 10 | Monitoring Device |
| 20 | Sucker rod string |
| 30 | Sucker rod pump |

1. A downhole monitoring device arranged in-line with a sucker rod string, the monitoring device comprising:
a housing arranged in-line with the sucker rod string;
a plurality of sensors arranged within the housing and configured for sensing at least one of: sucker rod string conditions and sucker rod string surrounding conditions;
a data acquisition, storage and control electronic circuitry arranged within the housing;
a power supply arranged within the housing connected to the monitoring device with electrical power,
where the plurality of sensors, the data acquisition, storage and control electronic circuitry and the power supply are interconnected.

2. A monitoring device according to claim 1, wherein the plurality of sensors comprises at least one of: an accelerometer, a strain gauge and a pressure and temperature sensor.

3. A monitoring device according to claim 1, wherein the housing comprises a top sub, a bottom sub and a main sub, wherein the top sub is connected to the bottom sub through the intermediate main sub.

4. A monitoring device according to claim 1, wherein the plurality of sensors comprises at least one sensor adapted for measuring at least one of: tension, compression and torque in the sucker rod string.

5. A monitoring device according to claim 1, wherein the electronic circuitry is encapsulated and comprises an accelerometer and electronics configured for data acquisition, processing and storage.

6. A monitoring device according to claim 1, wherein the plurality of sensors further comprises sensors for measuring pressure and temperature in a well.

7. A monitoring device according to claim 3, wherein the sensors for measuring pressure and temperature in the well are arranged in the bottom sub of the downhole monitoring device.

8. A monitoring device according to claim 6, wherein the sensors for measuring pressure and temperature in the well are arranged in the bottom sub of the downhole monitoring device.

9. A monitoring device according to claim 3, wherein said at least one sensor for measuring at least one of: tension, compression and torque in the sucker rod string are arranged in the bottom sub of the downhole monitoring device.

10. A monitoring device according to claim 3, wherein the plurality of sensors are arranged in the bottom sub.

11. A monitoring device according to claim 3, wherein the plurality of sensors are arranged in the top sub.

12. A monitoring device according to claim 3, wherein the power supply is arranged in the top sub.

13. A monitoring device according to claim 3, wherein the power supply is arranged in the bottom sub.

14. A monitoring device according to claim 1, wherein the power supply comprises a battery pack.

15. A system for monitoring at least one of: logging tension, compression, torque, temperature, pressure, position and acceleration, for the purpose of optimizing production of a well and identifying any downhole mechanical problems, wherein the system comprises: at least one monitoring device according to claim 1; a sucker rod string; and a sucker rod pump; said at least one monitoring device being arranged in-line with the sucker rod string.
